(19) United States
(12) Patent Application Publication
(10) Pub. No.: US 2021/0289924 A1
(43) Pub. Date: Sep. 23, 2021

(54) INTERACTIVE BACKPACK

(71) Applicant: TOYBAGS, S.L.U., Ondara (ES)

(72) Inventor: Antonio Noguera Ramis, Ondara (ES)

(21) Appl. No.: 16/326,431

(22) PCT Filed: Mar. 31, 2017
(86) PCT No.: PCT/ES2017/070192

§ 371 Date: Feb. 19, 2019

(51) Int. Cl. A45F 3/04; A63H 3/00; A63H 3/28; A63H 13/00; G11B 20/10; G06F 3/16

(52) U.S. Cl. CPC A45F 3/04; A63H 3/003; A63H 3/28; A45F 2003/003; G11B 20/10527; G06F 3/165; A63H 13/005

(57) ABSTRACT

The invention relates to an interactive backpack comprising a backpack body which in turn includes a figure of a character, the backpack also comprising: audio means for recording and reproducing sound; a movable part; mechanical means for moving the movable part; and control means comprising an actuator disposed in a position on the body of the backpack which is linked to the figure of the character, the actuator being configured to initiate sound recording and automatic reproduction of the recorded sound.

### CROSS-REFERENCE TO RELATED APPLICATIONS

This application claims priority of the Spanish utility model application No. 201631036, publication number ES1163386, filed on 16 Aug. 2016.

### FIELD OF THE INVENTION

The object of the present invention is related to an interactive backpack such as those used for carrying objects which could be, for example, school materials, sports materials, food, etc.

In particular, the present interactive backpack comprises interactive elements for the learning and entertainment of the child user.

### BACKGROUND OF THE INVENTION

The use of children's backpacks for children users to be able to transport their belongings to school, sports centers, playgrounds, etc. is known in the state of the art.

These known backpacks often have a configuration of a bag with a strap or handle used to carry it. They may also have images on one of the surfaces of the backpack.

From document ES1135108 an interactive backpack is known which has a figure with the appearance of a character that is generally known by children. The backpack comprises means for recording and reproducing sound, such that the user can record a voice message and listen to it through a speaker situated on the backpack. The recording is done after actuating a first button, while reproduction of the recording is done by actuating a second button. This backpack further comprises a mechanism situated on the mouth of the figure for simulating the movement of opening and closing the mouth while the recording is being reproduced.

However, it has been found that it is possible to facilitate the use of a backpack of this type for the user by simplifying the operation and encouraging the interaction of the user with the character.

### SUMMARY OF THE INVENTION

One object of the invention is an interactive backpack that comprises a backpack body which, in turn, comprises at least a figure of a character. The backpack additionally comprises audio means for recording and reproducing sound, at least a movable part, mechanical means for moving the movable part and control means. The control means can further comprise an actuator placed in a position of the body of the backpack which is linked to the figure of the character and which can be configured to initiate the recording of sound and the automatic reproduction of the recorded sound.

Thanks to the configuration of the actuator, which allows the sound to be recorded and then allows the recorded sound to be automatically reproduced, a second, additional actuator is not necessary to initiate the reproduction. By comprising a single actuator, the use of the interactive backpack is simplified.

On the other hand, the use of a movable part allows the user to perceive not only sounds but also movement. Furthermore, the position of the actuator allows the interaction between the user and the character represented by the figure to be enhanced.

According to one embodiment, the control means are configured to initiate the automatic reproduction of recorded sound when a predetermined period of time has passed in which the audio means do not receive sound.

Thanks to the predetermined time period, neither a second actuator nor a second actuation of the actuator by the user is necessary in order to produce the reproduction of the recorded sound. In other words, if, for example, the recorded sound is the voice of the user, the sound will be reproduced when the user finishes talking, without the user needing to perform any other action, such as actuating the actuator again or actuating an additional actuator.

According to one embodiment, the audio means comprise at least a microphone and at least a speaker.

According to one embodiment, the control means comprise at least a memory for storing at least an audio track.

According to one embodiment, the mechanical means comprise at least a motor and at least means for transmitting movement. This way, the movable part can be actuated and can move without the need for the user to intervene, thereby enhancing the sensation of automatic movement by, for example, the figure of the character.

According to one embodiment, the movable part of the backpack is an element linked to the figure of the character. This enhances the sensation that the character represented in the figure is moving by itself.

According to one embodiment, the movable part is the mouth of the figure of the character, and this way the sensation that figure is speaking on its own initiative is enhanced.

According to one embodiment, the control means are configured for synchronized and coordinated activation of the audio means and mechanical means. By reproducing a sound at the same time that the mechanical means move the movable part, the sensation that the figure is speaking and moving on its own is enhanced.

According to one embodiment, the actuator is further configured for turning on and off the control means and the audio means. This way, with a single actuator all of the actions of an operation cycle can be carried out, in other words, additional actuators are not needed to carry out the different functions, such as activation and deactivation.

On the other hand, by using a single actuator for turning the control means on and off, the use of the interactive backpack is simplified, facilitating the usage thereof and thus allowing the user to control the beginning and/or end of an operation cycle of the backpack.

According to one embodiment, the control means are configured to initiate the reproduction of a pre-recorded audio track after being turned on. This way, the user is more aware of the beginning of the operation cycle of the backpack.

According to one embodiment, in which the control means are configured to initiate the reproduction of a pre-recorded audio track before turning off, the user can confirm that an operation cycle of the backpack has come to its end.

According to one embodiment, a single actuation of the actuator produces a succession of recordings or reproductions, and thanks to this option, the user is not required to continuously activate the sound recording (and reproduction) function.

In other words, once the recording (and reproduction) function is activated, the successive sounds will be recorded and will be continuously reproduced until the user decides to end the operation cycle of the backpack with an actuation.

According to one embodiment, the actuator is arranged on an appendage that is joined to the backpack body.

According to one embodiment, the appendage is the nose of the figure of the character.

According to one embodiment, the backpack additionally comprises a power supply.

Other objects, advantages and characteristics of embodiments of the invention will become clear for a person skilled in the art based on the description or can be learned through the practical use of the invention.

### BRIEF DESCRIPTION OF THE DRAWINGS

Below particular embodiments of the present invention will be described by way of example and not limitation with reference to the attached drawings, in which:

FIG. 1 shows a diagram of some elements of the present invention;

FIG. 2 shows a schematic front perspective view of an embodiment of the present invention; and

FIG. 3 shows a diagram of a timeline according to one embodiment of the present invention.

### DETAILED DESCRIPTION OF THE INVENTION

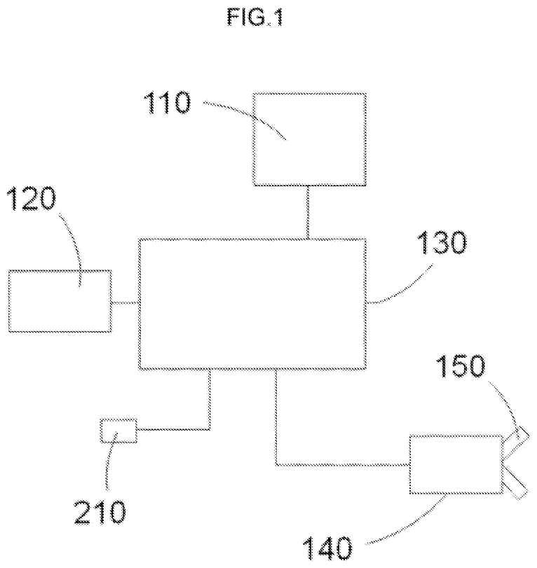

FIG. 1 schematically illustrates a set of elements according to one embodiment of the invention. FIG. 1 shows control means 130, audio means 110, mechanical means 150 and a power supply 120 joined by means of cables. According to another possible embodiment, the elements can be connected to each other wirelessly.

The control means 130 can additionally comprise an actuator 210 that can be configured for carrying out different functions, such as: turning on and off the control means and/or the audio means. By turning on the control means 130, an operation cycle of the backpack can begin, while when turning off the control means 130 an operation cycle is ended. On the other hand, by turning on the audio means 110, the recording of sound and the resulting automatic reproduction can be initiated, in other words, additional actuation of the recorded sound is not necessary.

Said actuator 210 can be, for example, a switch, a button or any element that allows the user to turn on the control means. According to another embodiment, the actuator can be an element activated by acoustic signals, for example, a voice.

On the other hand, the control means 130 can be configured to initiate the automatic reproduction of the recorded sound, in other words, an additional actuation is not necessary for the recorded sound to be reproduced. Said automatic reproduction can be produced after a predetermined period of time tₛ in which the audio means 110 do not receive sound. This period of time tₛ in which the audio means do not perceive sound can be, for example, 1 second.

On the other hand, the control means 130 can comprise at least a memory (not shown) for storing or recording at least an audio track. Said memory can be overwritten as a result of successive recordings. In alternative embodiments, the memory can be configured to comprise a plurality of audio tracks, through which sounds that are successively recorded can be stored in independent audio tracks without the need to overwrite previous recordings.

The audio tracks stored in the memory can be any type of reproducible sound, such as a voice, beeps, music or any other audio signal. Said audio tracks can be pre-recorded, in other words, they would not require the interaction of the user to be registered or could be made with the participation of the user, meaning the tracks recorded by the user after turning on the control and audio means.

Additionally, the control means 130 can be configured to activate the audio means 110 and the mechanical means 140 in a synchronized and coordinated way.

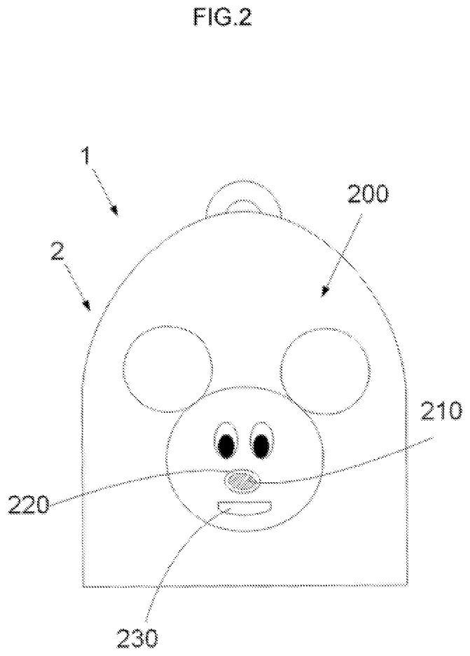

The audio means 110 can comprise at least a microphone (not shown) to be able to perceive the sounds, for example in the form of an audio track, and at least a speaker (not shown) to reproduce the recorded sounds. Both the microphone and the speaker can be located in the body of the backpack 2 or can be comprised in the figure of the character 200 (see FIG. 2).

The mechanical means 140 can comprise a motor (not shown) and at least a means for transmitting movement 150 that can be, for example, a movable arm, a cam or any other element or set of elements that allows the movable part of the backpack to move.

The power supply 120 provides electrical energy to all of the electrical and/or electronic elements of the present invention and can be, for example, a battery, a cell battery or a plurality of the same.

The elements 110, 120, 130, 140 used in the embodiments of the present invention can form different independent blocks (as shown in FIG. 1), form group blocks, for example, the audio means can be integrated in the control means, or, in another alternative embodiment, they can be integrated into a single unit.

FIG. 2 shows the front part of an interactive backpack 1 that comprises a body of a backpack 2 which can contain at least one figure of a character 200. The figure of a character 200 can project, either partially or completely, from the body of the backpack 2, meaning, it can partially or completely have a three-dimensional form. The figure of a character 200 can represent the entirety or a part of a character, for example, the face, the upper and/or lower extremities, which can be known, for example, by children, so as to encourage the interaction of the user with the backpack.

On the other hand, the body of the backpack 2 can comprise an appendage in which an actuator 210 for the control means can be housed. Said appendage can be joined to the body of the backpack 2 and/or to the figure of a character 200. In the embodiment of FIG. 2, the actuator 210 is located in the appendage 220, in this example in the nose of the character.

Likewise, the body of the backpack 2 can contain at least a movable part 230 that can be linked to the mechanical means and that can move by the action of the same. The movable part 230, for example, can be an element linked to the figure of a character 200. In FIG. 2, said movable part 230 is identified as the mouth of the character, such that when reproducing a recorded sound, the mouth of the character can move thanks to the mechanical means which can be coordinated and synchronized with the audio means by the control means.

Additionally, the backpack 1 can comprise lighting means, for example LEDs that light up at the same time that the sound is reproduced.

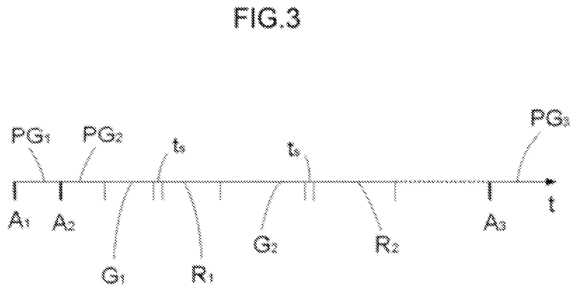

In FIG. 3 one can see an example of a complete operation cycle of the interactive backpack. In FIG. 3, the horizontal line represents the time t, with A₁ being the initial instant. To initiate the operation of the interactive backpack, a first actuation A₁ that can turn on the control means is carried out. Said actuation can consist of, for example, pushing or pressing the actuator. Optionally, after turning on the control means, the reproduction of a first pre-recorded audio track PG₁ can be initiated, which can be stored in the memory. Said first pre-recorded audio track can, for example, simulate the voice of the character greeting the user or could be a beep.

Then, after a second actuation A₂, the actuator turns on the audio means, and thus it is possible to initiate the reception of sounds through the microphone or other means for audio reception. Once the reception is initiated, the recording of sound, in other words, the user's voice, can begin and it is stored in the memory. Optionally, after turning on the audio means and before receiving the sounds, the control means can be configured to reproduce a second pre-recorded audio track PG₂ that can indicate the activation of said function to the user, meaning that the audio means are turned on and the recording can begin. The second pre-recorded audio track, for example, can imitate the voice of the character or be an audible signal, such as a beep, which can be equal to or different from the sound of the first pre-recorded audio track.

After beginning the reception of sounds or after the reproduction of a pre-recorded message, the recording of a first sound, for example, the voice of the user, can begin. When the reception of the sound is interrupted, for example the user stops talking, at a predetermined period of time tₛ, for example 0.5 seconds, the control means can be configured to automatically initiate the reproduction R₁ of the first recorded sound. Additionally, and coinciding with the beginning of the reproduction and throughout the same, the control means can activate the mechanical means and the means in a synchronized and coordinated way. In one example, the mechanical means can move the mouth of the figure of the character, reinforcing the sensation that the figure of the character is talking.

Once the reproduction R₁ of the first sound is concluded, and without the need for an additional actuation, the recording G₂ of a second sound, for example the voice of another user, can be initiated. According to one embodiment, the second sound can be rewritten over the first audio track of the first sound. According to another embodiment, in which the memory comprises more than one audio track, the second sound can be recorded in a second audio track that is different from the first audio track corresponding to the first sound. In the example of FIG. 3, the second sound is slightly longer than that of the first sound, although in another example both sounds can have the same length or significantly vary.

When the reception of the second sound stops during the predetermined time period tₛ, for example 0.5 seconds, the control means can be configured to automatically initiate the reproduction R₂ of the second recorded sound. Just like with the reproduction of the first recorded sound, by reproducing the second sound, the control means can activate the mechanical means and the audio means in a synchronized and coordinated way, so that the movable part moves at the same time that the second recorded sound is reproduced.

This enhances the sensation that figure of the character is talking by itself.

After the reproduction of the second sound, a plurality of recordings or reproductions can take place without the need for additional actuation, indicated in FIG. 3 by a dashed line, until the instant at which a third actuation A₃ is produced. The third actuation A₃ can turn off the control means and finalize an operation cycle of the interactive backpack. Optionally, the control means can be configured to initiate the reproduction of a third pre-recorded audio track PG₃ before turning off. Said third pre-recorded audio track can, for example, say goodbye to the user before the final disconnection.

In spite of the fact that only some particular embodiments and examples of the invention have been herein described, a person skilled in the art will understand that other alternative embodiments and/or uses of the invention are possible, as well as obvious modifications and equivalent elements. Furthermore, the present invention encompasses all of the possible combinations of specific embodiments that have been described. The scope of the present invention shall not be limited to specific embodiments, rather it must only be determined by an appropriate reading of the attached claims.

1. An interactive backpack that includes a backpack body having at least a figure of a character, the backpack comprising:
audio means for recording and reproducing sound;
at least a movable part;
mechanical means for moving the movable part; and
control means comprising an actuator placed in a position of the backpack body which is linked to the at least a figure of a character, wherein said control means is configured to initiate the recording of sound and automatic reproduction of the recorded sound.

2. The interactive backpack according to claim 1, wherein the control means is configured to initiate the automatic reproduction of the recorded sound when a predetermined period of time has passed in which the audio means do not receive sound.

3. The interactive backpack according to claim 1, wherein the audio means comprises at least a microphone and at least a speaker.

4. The interactive backpack according to claim 1, wherein the control means comprises a memory for storing at least one audio track.

5. The interactive backpack according to claim 1, wherein the control means comprises at least a motor and at least a means for transmitting movement.

6. The interactive backpack according to claim 1, wherein the at least a movable part of the backpack is an element linked to the at least a figure of a character.

7. The interactive backpack according to claim 1, wherein the at least a movable part is a mouth of the at least a figure of a character.

8. The interactive backpack according to claim 1, wherein the control means is configured for the synchronized and coordinated activation of the audio means and the mechanical means.

9. The interactive backpack according to claim 1, wherein the actuator is further configured to turn on and off the control means and the audio means.

10. The interactive backpack according to claim 1, wherein the control means is configured to initiate a reproduction of a pre-recorded audio track after being turned on.

11. The interactive backpack according to claim 1, wherein the control means is configured to initiate a reproduction of a pre-recorded audio track before turning off.

12. The interactive backpack according to claim 1, wherein a single actuation of the actuator produces a succession of recordings or reproductions.

13. The interactive backpack according to claim 1, wherein the actuator is arranged in an appendage that is joined to the backpack body.

14. The interactive backpack according to claim 13, wherein the appendage is a nose of the at least a figure of a character.

15. The interactive backpack according to claim 1, further comprising a power supply.
